(19) United States
(12) Patent Application Publication
(10) Pub. No.: US 2026/0181021 A1
(43) Pub. Date: Jun. 25, 2026

(54) METHOD AND SYSTEM FOR APPLYING CRYPTOGRAPHY POLICY

(71) Applicants: SAMSUNG SDS CO., LTD., Seoul (KR); Industry-Academic Cooperation Foundation, Dankook University, Gyeonggi-do (KR)

(72) Inventors: Jaehyun NAM, Gyeonggi-do (KR); Ji Hun KIM, Seoul (KR); Min Woo JEONG, Seoul (KR); Nam Sik HAM, Seoul (KR); Yoon Chan JHI, Seoul (KR); Ji Hoon CHO, Seoul (KR)

(73) Assignees: SAMSUNG SDS CO., LTD., Seoul (KR); Industry-Academic Cooperation Foundation, Dankook University, Gyeonggi-do (KR)

(21) Appl. No.: 19/327,239

(22) Filed: Sep. 12, 2025

(30) Foreign Application Priority Data
Dec. 24, 2024 (KR) 10-2024-0194876
May 30, 2025 (KR) 10-2025-0070877

(51) Int. Cl. H04L 9/40

(52) U.S. Cl. CPC H04L 63/166; H04L 63/20

(57) ABSTRACT

A method for applying a cryptography policy, performed by a computing system. The method may comprise acquiring information on cryptography policies associated with a first workload; determining, using the acquired information, a target cryptography policy to be applied to the first workload, the target cryptography policy including information on a target cryptographic library; and switching an existing cryptographic library applied to the first workload to the target cryptographic library.

### CROSS-REFERENCE TO RELATED APPLICATION

This application claims priority from Korean Patent Application No. 10-2024-0194876 filed on Dec. 24, 2024, and Korean Patent Application No. 10-2025-0070877 filed on May 30, 2025, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for applying a cryptography policy, and more particularly, to a method and system for applying a cryptography policy for cryptographic agility in a cloud-native environment.

### 2. Description of the Related Art

Recently, application development and operation environments have been transitioning to a cloud-native architecture. A cloud-native environment, which includes a microservices architecture, container-based deployment, and continuous integration and deployment (CI/CD), enables rapid service operation with flexible scalability and high availability. In such an environment, individual functions operate as independent services, and communication between services is conducted over a network.

To ensure the security of inter-service communication, service mesh technology is being widely adopted. In a service mesh architecture, a sidecar proxy (e.g., Envoy) is deployed for each service, and communication between proxies is automatically encrypted and authenticated using mutual Transport Layer Security (mTLS). This enables secure inter-service communication without the need to implement separate security logic in application code.

However, such a service mesh-based security structure has the following problems. First, since cryptography policies are applied uniformly, it is difficult to reflect security requirements specific to each service in a fine-grained manner. Second, changing statically configured cryptographic algorithms during operation is virtually impossible, and when changes are made, proxy restarts or full redeployment are required. Third, updating cryptographic configurations may cause service interruption. Fourth, with the advancement of quantum computing, security threats to existing cryptographic methods (e.g., RSA, ECC, etc.) are increasing, but the existing architecture does not support the flexible application of post-quantum cryptography (PQC).

Accordingly, there is an increasing need for technology that ensures cryptographic flexibility, allowing flexible configuration of service-specific security policies, enabling non-disruptive switching of cryptographic algorithms, and actively responding to technological changes.

### SUMMARY

An objective of the present disclosure is to provide a method and system that support a fine-grained cryptography policy capable of reflecting the security requirements of each service.

Another objective of the present disclosure is to provide a method and system for dynamically integrating and switching between various cryptographic libraries.

Yet another objective of the present disclosure is to provide a method and system capable of dynamically switching between cryptographic libraries in real time without affecting system availability.

The objectives of the present disclosure are not limited to those mentioned above, and other objectives not explicitly stated will be clearly understood by those skilled in the art based on the following description.

According to an aspect of an example embodiment of the present disclosure, there is provided a method for applying a cryptography policy, performed by a computing system. The method may comprise: acquiring information on cryptography policies associated with a first workload; determining, using the acquired information, a target cryptography policy to be applied to the first workload, the target cryptography policy including information on a target cryptographic library; and switching an existing cryptographic library applied to the first workload to the target cryptographic library, wherein the switching of the existing cryptographic library may comprise, while maintaining an existing cryptographic session established using the existing cryptographic library, establishing a new cryptographic session using the target cryptographic library for a new connection occurring for the first workload during the switching of the existing cryptographic library.

In some embodiments, the acquiring of the information on the cryptography policies may comprise acquiring information on cryptography policies by a resource unit associated with the first workload, the cryptography policies by the resource unit being set by a user.

In some embodiments, the information on cryptography policies by the resource unit may include information on at least one of a first-level policy applied at a cluster level, a second-level policy applied at a namespace level, and a third-level policy applied at a pod level.

In some embodiments, the determining of the target cryptography policy may comprise determining the target cryptography policy based on priorities set for cryptography policies by the respective resource unit.

In some embodiments, the priorities may be set such that a third-level policy applied at a pod level takes precedence over a second-level policy applied at a namespace level, and the second-level policy applied at the namespace level takes precedence over a first-level policy applied at a cluster level.

In some embodiments, the priorities may be set such that, when multiple cryptography policies are set for the same resource unit, a cryptography policy determined to have relatively higher security strength takes precedence.

In some embodiments, the determining of the target cryptography policy may comprise generating a Transport Layer Security (TLS) context for the first workload based on the target cryptography policy.

In some embodiments, the switching of the existing cryptographic library may comprise: comparing the existing cryptographic library and the target cryptographic library; and determining whether to switch cryptographic libraries based on a result of the comparison.

In some embodiments, the target cryptographic library may be configured to be dynamically loaded through a plugin-based architecture.

According to an aspect an example embodiment of the present disclosure, there is provided a cryptographic system comprising: a cryptography policy management unit configured to acquire information on cryptography policies associated with a first workload and determine, using the acquired information, a target cryptography policy to be applied to the first workload; and a cryptography policy execution unit configured to receive information on the target cryptography policy from the cryptography policy management unit and switch an existing cryptographic library applied to the first workload to a target cryptographic library specified in the target cryptography policy, wherein the cryptography policy execution unit may be configured to, while maintaining an existing cryptographic session established using the existing cryptographic library, establish a new cryptographic session using the target cryptographic library for a new connection occurring for the first workload during the switching to the target cryptographic library.

In some embodiments, the cryptography policies associated with the first workload may include cryptography policies by the resource unit associated with the first workload, cryptography policies by the resource unit being set by a user.

In some embodiments, cryptography policies by the resource unit may include at least one of a first-level policy applied at a cluster level, a second-level policy applied at a namespace level, and a third-level policy applied at a pod level.

In some embodiments, the cryptography policy execution unit may be configured to determine the target cryptography policy based on priorities set for cryptography policies by the respective resource unit, and the second-level policy is applied preferentially over the first-level policy, and the third-level policy is applied preferentially over the second-level policy.

In some embodiments, the cryptography policy management unit may be configured to generate a Transport Layer Security (TLS) context for the first workload based on the target cryptography policy.

In some embodiments, the cryptography policy execution unit may be implemented in a plugin-based architecture and is configured to dynamically load the target cryptographic library.

In some embodiments, the cryptographic system may be implemented in a service mesh architecture, the cryptography policy management unit is located in a control plane, and the cryptography policy execution unit is located in a data plane.

According to an aspect of an example embodiment of the present disclosure, there is provided a non-transitory computer-readable medium storing a computer program, the computer program, when executed by a processor, causing the processor to perform operations comprising: acquiring information on cryptography policies associated with a first workload; determining, using the acquired information, a target cryptography policy to be applied to the first workload, the target cryptography policy including information on a target cryptographic library; and switching an existing cryptographic library applied to the first workload to the target cryptographic library, wherein the operation of switching the existing cryptographic library comprises, while maintaining an existing cryptographic session established using the existing cryptographic library, establishing a new cryptographic session using the target cryptographic library for a new connection occurring for the first workload during the switching of the existing cryptographic library.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIGS. 1 and 2 are configuration diagrams of a cryptographic system according to an embodiment of the present disclosure;

FIG. 3 is a block diagram illustrating a plugin-based architecture of a cryptography policy execution unit according to an embodiment of the present disclosure;

FIG. 4 is a diagram illustrating a dynamic cryptographic switching method according to an embodiment of the present disclosure;

FIG. 5 is a diagram illustrating an overall process by which the cryptographic system applies a cryptography policy according to an embodiment of the present disclosure;

FIGS. 6 and 7 are diagrams illustrating examples of the operation of the cryptographic system;

FIG. 8 is a flowchart illustrating a method for applying a cryptography policy according to an embodiment of the present disclosure;

FIG. 9 is a flowchart illustrating an operation for determining a target cryptography policy according to priority; and

FIG. 10 is a hardware configuration diagram of a computing device according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

First, several terms used in the present disclosure will be described.

A cloud-native environment refers to an environment in which applications are designed, developed, deployed, and operated by maximizing the characteristics of cloud infrastructure. In the cloud-native environment, a cluster is the highest-level resource unit, representing the entire space in which each application is operated, a namespace is a unit that logically separates and groups resources within the cluster, and a pod is the smallest unit in which each application is actually executed.

Cryptographic agility refers to the capability of a system to efficiently handle changing security requirements and to switch to new cryptographic algorithms, protocols, and implementations without affecting availability.

Hereinafter, various embodiments of the present disclosure will be described in detail with reference to the accompanying drawings.

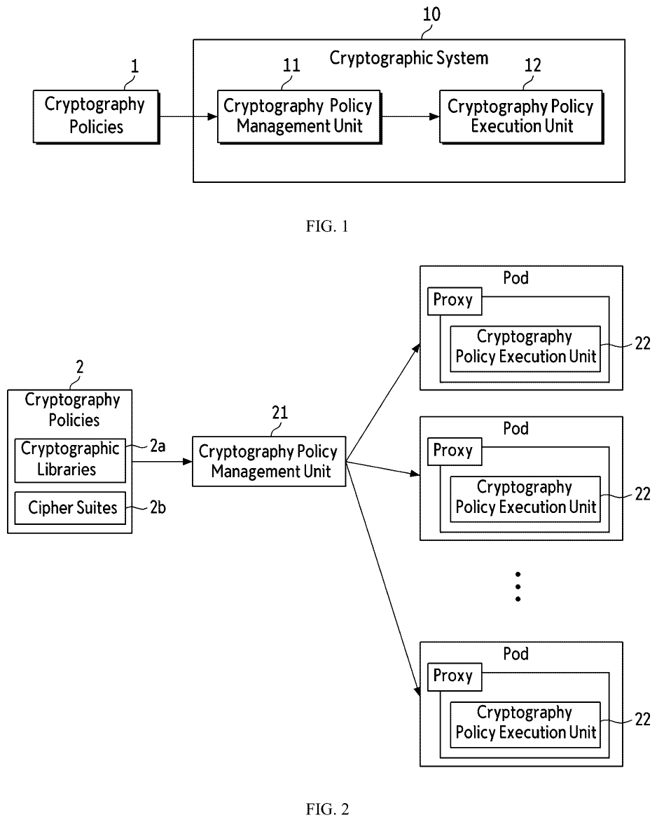

FIGS. 1 and 2 are configuration diagrams of a cryptographic system according to an embodiment of the present disclosure.

Referring first to FIG. 1, a cryptographic system 10 may include a cryptography policy management unit 11 and a cryptography policy execution unit 12.

The cryptographic system 10 is a system that provides cryptographic agility in a cloud-native environment. In the cloud-native environment, it is difficult to apply cryptography policies in a fine-grained manner according to the security requirements of each service, and since existing cryptographic configurations are statically set, there are limitations in applying a different cryptographic algorithm or adding a new cryptographic algorithm. In addition, there is a problem in that updating a cryptographic algorithm entails an interruption of an operating service or system.

Accordingly, the cryptographic system 10 may manage cryptography policies in a fine-grained manner through the cryptography policy management unit 11, and may provide cryptographic agility by dynamically integrating the cryptographic libraries in a plugin-based architecture through the cryptography policy execution unit 12.

Hereinafter, the functions of each component of the cryptographic system 10 will be described in detail with reference to FIG. 2.

Referring to FIG. 2, the cryptographic system 10 may be implemented in a service mesh architecture. Specifically, a cryptography policy management unit 21 may be located in a control plane, and cryptography policy execution units 22 may be located in respective proxies in a data plane, so as to perform management and execution of cryptography policies.

The cryptography policy management unit 21, which is a component that performs the function of managing and controlling cryptography policies, plays a central role in managing the cryptography policies in the cloud-native environment. The cryptography policy management unit 21 may collect cryptography policies 2 set by a user, and analyze the collected cryptography policies 2 to determine an optimal cryptography policy according to the characteristics of each workload. Here, the term “workload” refers to an execution unit of an application or process that performs a specific task in a cloud environment.

In one embodiment, the cryptography policy management unit 21 may collect in real time the cryptography policies 2 and may detect, in real time, changes in the cryptography policies 2. Here, the cryptography policies 2 may include configuration information on cryptographic libraries 2a and cipher suites 2b. The user may set the cryptography policies 2 for each resource unit, for example, each cluster, namespace, or pod.

According to one embodiment, the cryptography policy management unit 21 may perform hierarchical policy management. Specifically, the cryptography policy management unit 21 may manage cryptography policies by resource unit in a three-level hierarchical structure.

A first-level policy is a higher-level cryptography policy that can maintain consistency across an entire cluster and may be applied at a cluster level. The first-level policy may also be referred to as a “cluster-level policy” or “cluster policy.” A second-level policy is a customized cryptography policy set to reflect specialized security requirements of a specific project or work group and may be applied at a namespace level. The second-level policy may also be referred to as a “namespace-level policy” or “namespace policy.” A third-level policy is a detailed cryptography policy set to meet the unique data sensitivity and performance requirements of an individual workload and may be applied at a pod level. The third-level policy may also be referred to as a “pod-level policy” or “pod policy.”

Although in this embodiment, cryptography policies are defined and managed in a three-level hierarchical structure, the present disclosure is not limited thereto. For example, depending on the security requirements of the cloud-native environment or the characteristics of each workload, a new policy level may be added, or the existing policy level structure may be reduced and simplified.

According to one embodiment, the cryptography policy management unit 21 may determine an optimal cryptography policy for each workload. In this case, when a conflict occurs between cryptography policies applicable to a workload, the cryptography policy management unit 21 may determine a cryptography policy suitable for the workload by applying a predefined priority criterion.

As described above, a cryptography policy may be individually set for each resource unit, and when multiple cryptography policies are set in an overlapping fashion for different resource units such as clusters, namespaces, or pods, two or more cryptography policies that are simultaneously applicable to a particular workload may exist. In this case, the cryptography policy management unit 21 may determine a final cryptography policy to be applied based on the priority for each resource unit.

For example, when there exist a first-level policy applied at a cluster level, a second-level policy applied at a namespace level, and a third-level policy applied at a pod level, priorities may be set such that the third-level policy takes precedence over the second-level policy and the second-level policy takes precedence over the first-level policy. Accordingly, a cryptography policy set at a higher level may be redefined or extended at a lower level.

Also, when multiple cryptography policies are set for the same resource unit, the cryptography policy management unit 21 may determine priorities according to the security strength of each cryptography policy. In this case, the security strength may be determined by comprehensively evaluating factors such as the type of cryptographic algorithm, key length, version of the protocol used, strength of the hash function, and the presence of known vulnerabilities. As a result of the evaluation, a cryptography policy determined to have relatively higher security strength may be applied preferentially, thereby effectively meeting the security requirements for each workload.

According to one embodiment, the cryptography policy management unit 21 may support real-time policy updates. Specifically, the cryptography policy management unit 21 may generate a new Transport Layer Security (TLS) context based on changes to the cryptography policies 2 and propagate it to the cryptography policy execution units 22, which will be described later, thereby supporting real-time policy updates. In this case, the cryptography policy management unit 21 may adopt a gradual switching method to minimize service interruption or performance degradation, and may sequentially propagate, for each workload, the TLS context to which the changes have been applied. Here, the TLS context refers to configuration information necessary for establishing a TLS session according to the cryptography policies 2, and may include TLS version information, cryptographic library information, and cryptographic algorithm information.

The cryptography policy execution units 22 are components that manage cryptographic libraries and actually apply cryptography policies. The cryptography policy execution units 22 dynamically switch cryptographic mechanisms without service interruption in the cloud-native environment, and provide the capability to add new cryptographic libraries as needed. The cryptography policy execution units 22 may be located in the proxies within the respective pods and may operate therein.

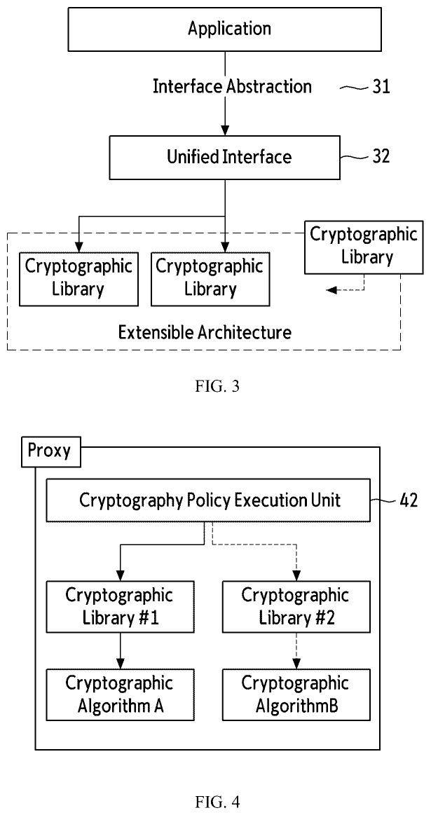

According to one embodiment, the cryptography policy execution units 22 may be implemented in a plugin-based architecture. Specifically, cryptographic libraries may be configured in the form of plugins so that addition, removal, or switching of cryptographic libraries can be handled, as required, without service interruption. This will be described with reference to FIG. 3.

FIG. 3 is a block diagram illustrating a plugin-based architecture of a cryptography policy execution unit according to an embodiment of the present disclosure.

Referring to FIG. 3, the cryptography policy execution unit configures a unified interface 32 through interface abstraction 31, thereby enabling an application to access cryptographic libraries using the same calling method.

Specifically, the unified interface 32 provides a consistent calling method for all cryptographic libraries managed by the cryptography policy execution unit. Through this structure, even if a specific cryptographic library is replaced or added, the cryptographic library may be accessed in the same manner through the unified interface 32.

In addition, each cryptographic library is configured in the form of a plugin so that a new cryptographic library may be added or an existing library may be replaced. This plugin-based structure allows a new cryptographic library to be added or an existing cryptographic library to be replaced. Further, when a plugin is replaced, the cryptographic state of an existing cryptographic session may be maintained while applying a new cryptographic library only to a new cryptographic session. That is, while maintaining an existing cryptographic session established using an existing cryptographic library, a new cryptographic session may be established for a new connection using a new cryptographic library.

Referring again to FIGS. 1 and 2, according to one embodiment, the cryptography policy execution unit 22 may dynamically switch cryptographic mechanisms during system operation. Specifically, when a change occurs in a cryptography policy, the cryptography policy execution unit 22 may dynamically switch the existing cryptographic configuration to a new cryptographic library and algorithm.

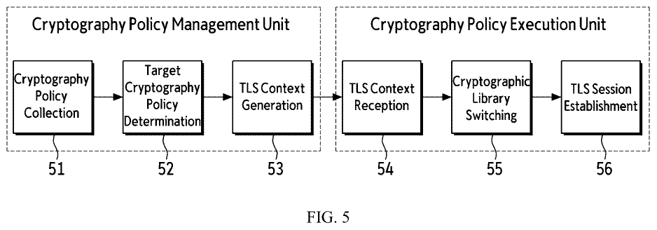

FIG. 4 is a diagram illustrating a dynamic cryptographic switching method according to an embodiment of the present disclosure.

As illustrated in FIG. 4, when a change occurs in a cryptography policy with cryptographic library #2 and cryptographic algorithm B applied, a cryptography policy execution unit 42 may switch in real time to cryptographic library #1 and cryptographic algorithm A. In this case, the existing TLS session to which the existing cryptographic algorithm is applied may be maintained, while a new TLS session to which the new cryptographic algorithm is applied is separately generated and operated in parallel. Thereafter, by switching to the new TLS session in response to the existing TLS session being terminated, gradual switching between cryptographic mechanisms may be implemented without service interruption.

As such, the cryptography policy execution unit is capable of easily replacing or expanding cryptographic libraries through the plugin-based architecture, and can promptly incorporate the latest cryptographic technologies or enhanced cryptographic algorithms. Furthermore, even when replacing cryptographic libraries, switching can be performed without service interruption and without modifying existing application code, thereby ensuring service continuity.

Meanwhile, the aforementioned cryptographic system 10 may be implemented with at least one computing device. For example, all functions of the cryptographic system 10 may be implemented in one computing device. In another example, first and second functions of the cryptographic system 10 may be implemented in first and second computing devices, respectively. In yet another example, a certain function of the cryptographic system 10 may be implemented across a plurality of computing devices.

The term “computing device” may encompass any device having a computing function, and an exemplary computing device is illustrated in FIG. 10. As a computing device is an aggregate of various components (e.g., a memory, a processor, etc.) that interact with each other, it may also be referred to as a “computing system”. In addition, a computing system may refer to an aggregate of a plurality of computing devices interacting with each other.

Hereinafter, the operation of the cryptographic system 10 will be described in further detail with reference to FIG. 5 and subsequent drawings.

FIG. 5 illustrates an overall process by which the cryptographic system according to an embodiment of the present disclosure applies a cryptography policy. The blocks (i.e., 51 through 56) depicted in FIG. 5 may be understood as modules (or functional blocks) constituting a cryptography policy management unit and a cryptography policy execution unit.

As illustrated in FIG. 5, the cryptography policy management unit may sequentially perform a cryptography policy collection step 51, a target cryptography policy determination step 52, and a TLS context generation step 53, and the cryptography policy execution unit may sequentially perform a TLS context reception step 54, a cryptographic library switching step 55, and a TLS session establishment step 56.

First, in the cryptography policy collection step 51, the cryptography policy management unit may collect information on cryptography policies set by a user, and may detect in real time changes in the cryptography policies. The cryptography policies may be set for each resource unit. For example, the cryptography policies may be set for each cluster, namespace, or pod.

Thereafter, in the cryptography policy determination step 52, the cryptography policy management unit may analyze configuration information on collected cryptography policies to determine an optimal cryptography policy for each workload. Specifically, the cryptography policy management unit may evaluate cryptography policies related to each workload based on priority to determine an optimal cryptography policy. The priorities of the cryptography policies may be set such that a third-level policy takes precedence over a second-level policy, and a second-level policy takes precedence over a first-level policy. In addition, among cryptography policies within the same level, a cryptography policy having a higher security strength is applied preferentially. Accordingly, the cryptography policy management unit may determine an optimal cryptography policy for each workload by comprehensively considering priority and security strength.

Thereafter, in the TLS context generation step 53, a TLS context for each workload may be generated using information on the cryptography policy determined for each workload. The TLS context refers to information necessary for establishing a TLS session, and may include a TLS version, a cryptographic library, and a cryptographic algorithm. The generated TLS context may be delivered to a proxy within a pod associated with each workload.

Thereafter, the cryptography policy execution unit receives the TLS context from the cryptography policy management unit in the TLS context reception step 54, and performs a switching operation to the cryptographic library defined in the TLS context in the cryptographic library switching step 55. Thereafter, in the TLS session establishment step 56, a final TLS session is established using an optimized cryptographic algorithm.

Specifically, an existing cryptographic library may be switched in real time with a new cryptographic library defined in the TLS context to establish a new TLS session using the updated new cryptographic library while maintaining the existing TLS session using the existing cryptographic library. The activated existing cryptographic library is gradually replaced with the new cryptographic library, and no service interruption occurs in this process.

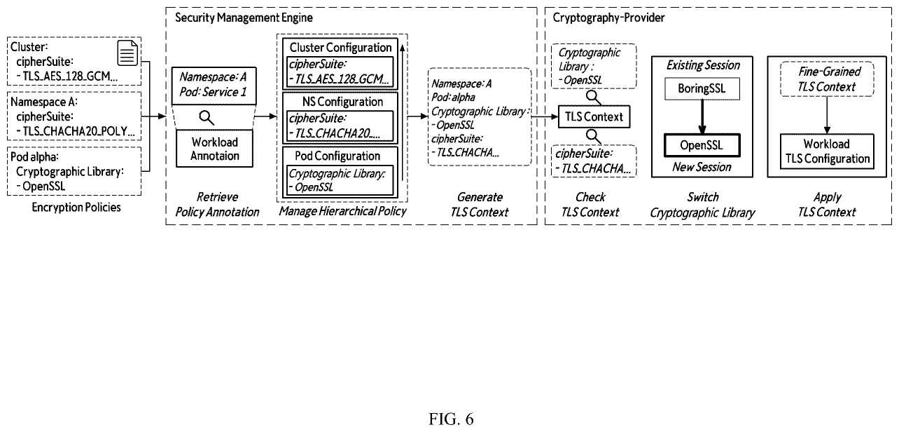

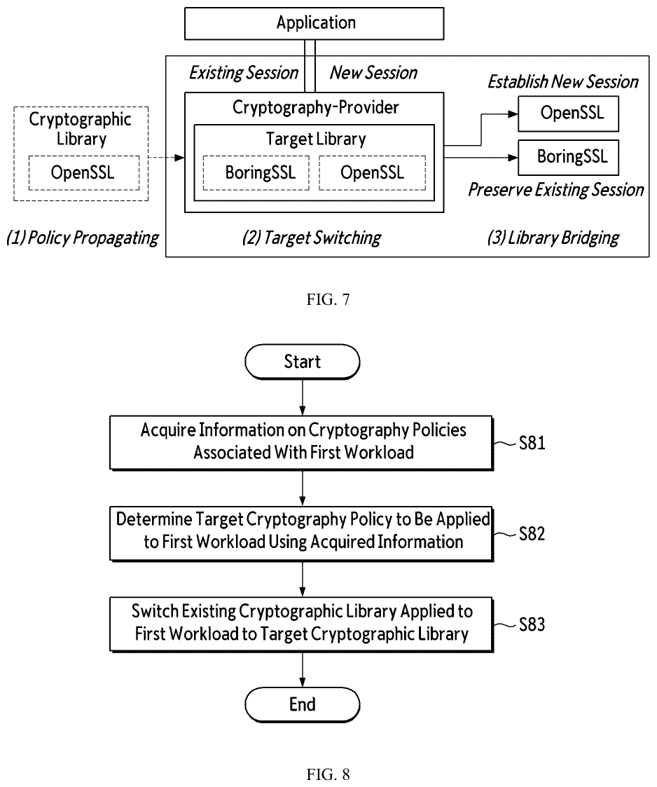

Hereinafter, specific examples of the operation of the cryptographic system according to an embodiment of the present disclosure will be described in further with reference to FIGS. 6 and 7.

FIGS. 6 and 7 specifically illustrate the operation of the cryptographic system according to an embodiment of the present disclosure. Referring to FIGS. 6 and 7, “Security Management Engine” refers to a cryptography policy management unit, and “Cryptography-Provider” refers to a cryptography policy execution unit of the cryptographic system.

Referring to FIG. 6, cryptography policies set by a user are collected. As illustrated, the cryptography policies may be classified into a cluster-level policy, a namespace-level policy, and a pod-level policy, and cryptography policies refined by resource unit may be collected.

Based on information on the collected cryptography policies, cryptography policies related to each workload may be derived, and a target cryptography policy for each workload is determined by applying a priority rule to the cryptography policies. As illustrated, even if a cluster-level policy is configured with the TLS_AES_128_GCM cryptographic algorithm, a namespace-level policy is applied preferentially if it is configured with the TLS_CHACHA20_POLY1305 cryptographic algorithm.

Thereafter, a TLS context is generated for each workload, and an existing library, BoringSSL, is switched to the cryptographic library specified in the TLS context, OpenSSL. This will be described in further detail with reference to FIG. 7.

Referring to FIG. 7, based on information on a propagated cryptography policy, BoringSSL, is switched to the target cryptographic library, OpenSSL. In this process, the existing cryptographic library and the target cryptographic library may be managed simultaneously, and an existing session and a new session may operate in parallel.

Specifically, the cryptographic state of the existing session is maintained using the existing cryptographic library, BoringSSL, thereby ensuring connection stability. In contrast, for the new session, the updated target cryptographic library, OpenSSL, is applied, and a new cryptographic session is established. This allows an existing connection to maintain continuity with the existing cryptographic library while enhancing security for a new connection using the latest cryptographic library.

Once the library switching is complete, that is, after all existing sessions are terminated, the existing cryptographic library is deactivated. Accordingly, until the existing sessions are completely terminated, the existing cryptographic library is maintained, enabling the library switching to be performed without service interruption.

Thus far, with reference to FIGS. 1 through 4, the configuration and functions of the cryptographic system according to an embodiment of the present disclosure have been described in detail, and with reference to FIGS. 5 through 7, the operation of the cryptographic system according to an embodiment of the present disclosure has been described in detail. The aforementioned embodiments can be more fully understood with reference to other embodiments to be described below. Furthermore, the technical idea that can be understood from the embodiments described above can be reflected in other embodiments to be described below, even if not explicitly stated.

Hereinafter, with reference to FIG. 8 and subsequent drawings, a method for applying a cryptography policy according to an embodiment of the present disclosure will be described in detail. For the convenience of understanding, the following description assumes that all steps/operations of methods to be described below are performed by the cryptographic system 10. Accordingly, when the subject of a specific step/operation is omitted, it may be understood that the step/operation is performed by the cryptographic system 10. However, in an actual environment, some steps of the methods to be described below may be performed by another computing device.

FIG. 8 is a flowchart illustrating a method for applying a cryptography policy according to an embodiment of the present disclosure. It should be understood, however, that this is merely exemplary for achieving the objectives of the present disclosure, and that certain steps may be added or removed as necessary.

Referring to FIG. 8, in step S81, information on cryptography policies associated with a first workload may be acquired. Here, the cryptography policy associated with the first workload refers to a cryptography policy that is set and defined as being applied to resource units constituting the first workload.

Specifically, a user may set a cryptography policy for each resource unit, and configuration information on cryptography policies applied to the resource units constituting the first workload may be acquired from the configuration information. The configuration information may include information on at least one of a first-level policy applied at a cluster level, a second-level policy applied at a namespace level, and a third-level policy applied at a pod level.

Thereafter, in step S82, using the configuration information, a target cryptography policy to be applied to the first workload may be determined. The target cryptography policy may include information on a target cryptographic library.

Specifically, the target cryptography policy may be determined based on a priority set for each resource unit cryptography policy. As described above, cryptography policies may be classified into a first-level policy applied at a cluster level, a second-level policy applied at a namespace level, and a third-level policy applied at a pod level. In this case, the second-level policy may be applied preferentially over the first-level policy, and the third-level policy may be applied preferentially over the second-level policy. That is, a higher-level policy may be selectively redefined or extended according to a lower-level policy.

Thereafter, based on the determined target cryptography policy, a TLS context for the first workload may be generated. The TLS context refers to configuration information necessary for establishing a TLS session according to the target cryptography policy, and may include information on a TLS version, a cryptographic library (i.e., the target cryptographic library), and a cryptographic algorithm.

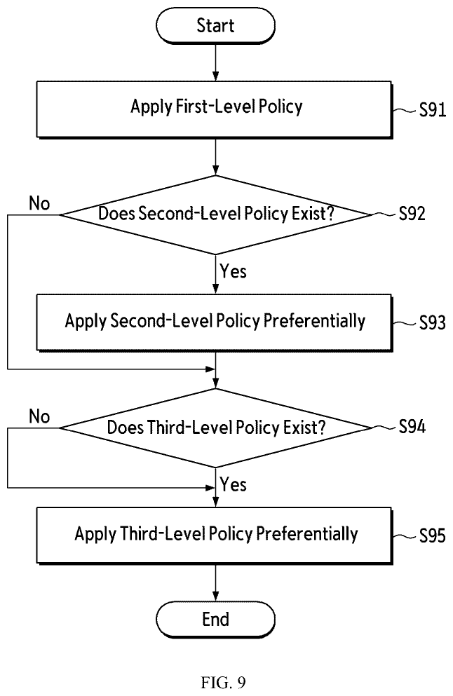

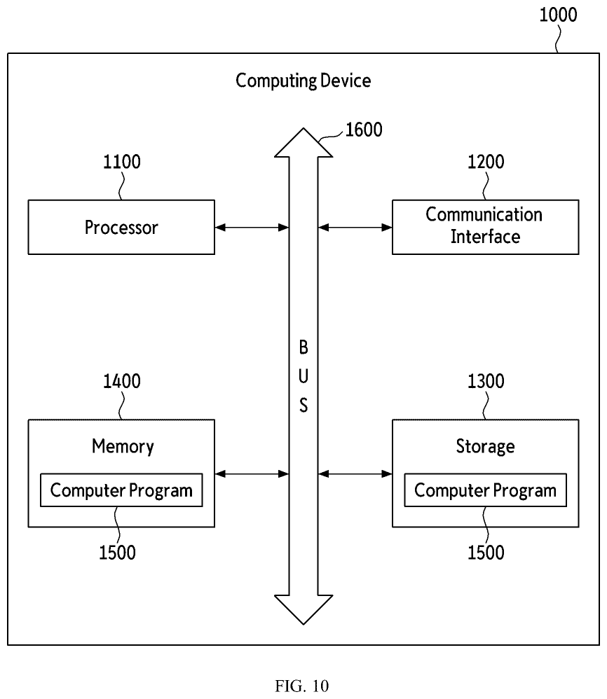

Hereinafter, with reference to FIG. 9, an operation for determining a target cryptography policy according to priority will be described in detail.

FIG. 9 is a flowchart illustrating an operation for determining a target cryptography policy according to priority.

Referring to FIG. 9, a first-level policy related to the first workload is applied (S91), and it is determined whether a second-level policy related to the first workload exists (S92). If the second-level policy exists (Yes), the second-level policy is applied preferentially, and then, it is determined whether a third-level policy related to the first workload exists (S93). If the third-level policy exists (Yes), the third-level policy is applied preferentially (S94). In this manner, by applying a lower-level policy preferentially over a higher-level policy, detailed cryptographic management tailored to the characteristics of each workload is enabled.

Meanwhile, when multiple cryptography policies are set for the same resource unit, a cryptography policy determined to have relatively higher security strength may be applied preferentially.

Referring again to FIG. 8, in step S83, an existing cryptographic library applied to the first workload may be switched to the target cryptographic library. This switching process may be performed in such a manner that the existing cryptographic library is gradually replaced with the target cryptographic library.

Specifically, before switching to the target cryptographic library, the existing cryptographic library and the target cryptographic library may be compared, and whether to switch cryptographic libraries may be determined based on the result of the comparison. For example, when the existing cryptographic library contains a security vulnerability or suffers from performance degradation, it may be determined to switch to the target cryptographic library.

When it is determined to switch to the target cryptographic library, in step S83, while maintaining an existing cryptographic session established using the existing cryptographic library, a new cryptographic session may be established for a new connection occurring for the first workload during the switching to the target cryptographic library. That is, the cryptographic state of an existing session may be maintained via the existing cryptographic library to ensure connection stability, while applying a new cryptographic session configured with the updated target cryptographic library to a new session.

As described above with reference to FIGS. 8 and 9, the method for applying a cryptography policy according to an embodiment of the present disclosure has been described in detail. As described above, by setting and managing cryptography policies refined for each resource unit, a cryptography policy suitable for the security requirements of each workload can be flexibly applied in various cloud environments.

In addition, when switching cryptographic libraries, by maintaining an existing cryptographic session and applying a new cryptographic library only to a new connection, it is possible to realize a non-disruptive switching without service interruption.

Furthermore, by managing cryptographic libraries in a plugin-based manner, flexibility is provided to dynamically add and load new cryptographic libraries. Accordingly, even if the latest cryptographic technology is introduced, it can be applied to an existing system without burden, and an immediate response can be made when a security vulnerability is discovered.

Hereinafter, with reference to FIG. 10, an exemplary computing device/system 1000 capable of implementing the aforementioned cryptographic system 10 will be described.

FIG. 10 is a hardware configuration diagram of a computing device according to some embodiments of the present disclosure.

Referring to FIG. 10, the computing device 1000 may include at least one processor 1100, a bus 1600, a communication interface 1200, a memory 1400 that loads a computer program 1500 executed by the processor 1100, and a storage 1300 that stores the computer program 1500. FIG. 10 illustrates only the components relevant to the embodiments of the present disclosure. Thus, although not illustrated, other general-purpose components may also be included in the computing device 1000. That is, the computing device 1000 may further include various components in addition to those depicted in FIG. 10. Also, in some embodiments, the computing device 1000 may be configured without some of the components illustrated in FIG. 10. Each component of the computing device 1000 will hereinafter be described.

The processor 1100 may control the overall operation of each component of the computing device 1000. The processor 1100 may include at least one processor such as a central processing unit (CPU), microprocessor unit (MPU), microcontroller unit (MCU), or graphics processing unit (GPU), all of which are well-known in the technical field of the present disclosure. Additionally, the processor 1100 may perform operations for at least one application or program for executing operations/methods according to embodiments of the present disclosure. The computing device 1000 may include one or more processors.

The memory 1400 may store various data, instructions, and/or information. The memory 1400 may load the computer program 1500 from the storage 1300 to execute the operations/methods according to embodiments of the present disclosure. The memory 1400 may be implemented as volatile memory such as random-access memory (RAM), but the present disclosure is not limited thereto.

The bus 1600 may provide a communication function between the components of the computing device 1000. The bus 1600 may be implemented as various types of buses, such as an address bus, data bus, or control bus.

The communication interface 1200 may support wired or wireless Internet communication for the computing device 1000. In addition, the communication interface 1200 may support various types of communication methods beyond internet communication. For this, the communication interface 1200 may include a communication module well known in the technical field of the present disclosure.

The storage 1300 may store one or more computer programs 1500 in a non-transitory manner. The storage 1300 may include a non-volatile memory such as a read-only memory (ROM), erasable programmable ROM (EPROM), electrically erasable programmable ROM (EEPROM), flash memory, a hard disk, a removable disk, or a computer-readable recording medium well known in the technical field of the present disclosure.

The computer program 1500 may include one or more instructions which, when loaded into the memory 1400, cause the processor 1100 to perform various operations/methods according to embodiments of the present disclosure. That is, by executing the loaded instructions, the processor 1100 may perform the operations/methods according to the various embodiments of the present disclosure.

In one example, the computer program 1500 may include instructions for the operations of: acquiring information on cryptography policies associated with a first workload; determining, using the acquired information, a target cryptography policy to be applied to the first workload, the target cryptography policy including information on a target cryptographic library; and switching an existing cryptographic library applied to the first workload to the target cryptographic library, wherein the switching of the existing cryptographic library comprises, while maintaining an existing cryptographic session established using the existing cryptographic library, establishing a new cryptographic session using the target cryptographic library for a new connection occurring for the first workload during the switching of the existing cryptographic library.

In another example, the computer program 1500 may include instructions for performing at least some of the steps/operations/methods described with reference to FIGS. 1 through 15.

Meanwhile, in some embodiments, the computing device 1000 illustrated in FIG. 10 may refer to a virtual machine implemented based on cloud technology. For example, the computing device 1000 may be a virtual machine operating on one or more physical servers included in a server farm. In this case, at least some of the processor 1100, memory 1400, and storage 1300 depicted in FIG. 10 may correspond to virtual hardware components, and the communication interface 1200 may also be implemented as a virtualized networking component such as a virtual switch.

So far, a variety of embodiments of the present disclosure and the effects according to embodiments thereof have been mentioned with reference to FIGS. 1 to 10. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for applying a cryptography policy, performed by a computing system, comprising:
acquiring information on cryptography policies associated with a first workload;
determining, using the acquired information, a target cryptography policy to be applied to the first workload, the target cryptography policy including information on a target cryptographic library; and
switching an existing cryptographic library applied to the first workload to the target cryptographic library,
wherein the switching of the existing cryptographic library comprises, while maintaining an existing cryptographic session established using the existing cryptographic library, establishing a new cryptographic session using the target cryptographic library for a new connection occurring for the first workload during the switching of the existing cryptographic library.

2. The method of claim 1, wherein the acquiring of the information on the cryptography policies comprises acquiring information on cryptography policies by a resource unit associated with the first workload, the cryptography policies by the resource unit being set by a user.

3. The method of claim 2, wherein the information on cryptography policies by the resource unit includes information on at least one of a first-level policy applied at a cluster level, a second-level policy applied at a namespace level, and a third-level policy applied at a pod level.

4. The method of claim 2, wherein the determining of the target cryptography policy comprises determining the target cryptography policy based on priorities set for cryptography policies by the respective resource unit.

5. The method of claim 4, wherein the priorities are set such that a third-level policy applied at a pod level takes precedence over a second-level policy applied at a namespace level, and the second-level policy applied at the namespace level takes precedence over a first-level policy applied at a cluster level.

6. The method of claim 4, wherein the priorities are set such that, when multiple cryptography policies are set for the same resource unit, a cryptography policy determined to have relatively higher security strength takes precedence.

7. The method of claim 1, wherein the determining of the target cryptography policy comprises generating a Transport Layer Security (TLS) context for the first workload based on the target cryptography policy.

8. The method of claim 1, wherein the switching of the existing cryptographic library comprises: comparing the existing cryptographic library and the target cryptographic library; and determining whether to switch cryptographic libraries based on a result of the comparison.

9. The method of claim 1, wherein the target cryptographic library is configured to be dynamically loaded through a plugin-based architecture.

10. A cryptographic system comprising:
a cryptography policy management unit configured to acquire information on cryptography policies associated with a first workload and determine, using the acquired information, a target cryptography policy to be applied to the first workload; and
a cryptography policy execution unit configured to receive information on the target cryptography policy from the cryptography policy management unit and switch an existing cryptographic library applied to the first workload to a target cryptographic library specified in the target cryptography policy,
wherein the cryptography policy execution unit is configured to, while maintaining an existing cryptographic session established using the existing cryptographic library, establish a new cryptographic session using the target cryptographic library for a new connection occurring for the first workload during the switching to the target cryptographic library.

11. The cryptographic system of claim 10, wherein the cryptography policies associated with the first workload include cryptography policies by the resource unit associated with the first workload, cryptography policies by the resource unit being set by a user.

12. The cryptographic system of claim 11, wherein cryptography policies by the resource unit include at least one of a first-level policy applied at a cluster level, a second-level policy applied at a namespace level, and a third-level policy applied at a pod level.

13. The cryptographic system of claim 12, wherein
the cryptography policy execution unit is configured to determine the target cryptography policy based on priorities set for cryptography policies by the respective resource unit, and
the second-level policy is applied preferentially over the first-level policy, and the third-level policy is applied preferentially over the second-level policy.

14. The cryptographic system of claim 10, wherein the cryptography policy management unit is configured to generate a Transport Layer Security (TLS) context for the first workload based on the target cryptography policy.

15. The cryptographic system of claim 10, wherein the cryptography policy execution unit is implemented in a plugin-based architecture and is configured to dynamically load the target cryptographic library.

16. The cryptographic system of claim 10, wherein
the cryptographic system is implemented in a service mesh architecture,
the cryptography policy management unit is located in a control plane, and
the cryptography policy execution unit is located in a data plane.

17. A non-transitory computer-readable medium storing a computer program, the computer program, when executed by a processor, causing the processor to perform operations comprising:
acquiring information on cryptography policies associated with a first workload;
determining, using the acquired information, a target cryptography policy to be applied to the first workload, the target cryptography policy including information on a target cryptographic library; and
switching an existing cryptographic library applied to the first workload to the target cryptographic library,
wherein the operation of switching the existing cryptographic library comprises, while maintaining an existing cryptographic session established using the existing cryptographic library, establishing a new cryptographic session using the target cryptographic library for a new connection occurring for the first workload during the switching of the existing cryptographic library.
